(19) United States
(12) Patent Application Publication
(10) Pub. No.: US 2026/0331772 A1
(43) Pub. Date: Oct. 22, 2026

(54) ELECTRONIC DEVICE

(71) Applicant: HUAWEI TECHNOLOGIES CO., LTD., Shenzhen (CN)

(72) Inventors: Liang Lu, Xi'an (CN); Xinpeng Chen, Xi'an (CN); Yun Zhang, Xi'an (CN); Jinglei Zhang, Xi'an (CN); Runnan Chai, Xi'an (CN); Yunji Zhang, Xi'an (CN); Taizhan Liu, Xi'an (CN)

(73) Assignee: HUAWEI TECHNOLOGIES CO., LTD., Shenzhen (CN)

(21) Appl. No.: 19/701,650

(22) Filed: Jun. 8, 2026

Related U.S. Application Data
(63) Continuation of application No. PCT/CN2024/133766, filed on Nov. 22, 2024.

(30) Foreign Application Priority Data
Dec. 7, 2023 (CN) 202311683880.2

(51) Int. Cl. H01Q 5/30; H01Q 1/22

(52) U.S. Cl. CPC H01Q 5/30; H01Q 1/22

(57) ABSTRACT

This application provides an electronic device. The electronic device includes an antenna. A conductive part of a side frame of the electronic device is used as a radiator of the antenna, so that user experience during satellite navigation or communication can be improved. The antenna further includes a first feeding circuit, a second feeding circuit, and a tuning circuit. The first feeding circuit is configured to transmit an electrical signal in a first frequency band, and the second feeding circuit is configured to transmit an electrical signal in a second frequency band. A controller of the electronic device is electrically connected to the tuning circuit of the antenna, and the controller is configured to switch a circuit state of the tuning circuit, so that the antenna operates in the first frequency band or the second frequency band.

### CROSS-REFERENCE TO RELATED APPLICATIONS

This application is a continuation of International Application No. PCT/CN2024/133766, filed on Nov. 22, 2024, which claims priority to Chinese Patent Application No. 202311683880.2, filed on Dec. 7, 2023. The disclosures of the aforementioned applications are hereby incorporated by reference in their entireties.

### TECHNICAL FIELD

This application relates to the field of wireless communication, and in particular, to an electronic device.

### BACKGROUND

With continuous evolution of mobile communication technologies, satellite communication technologies gradually become a major feature function of mobile terminal devices. However, an industrial design (industrial design, ID) development trend of an electronic device is a large screen-to-body ratio and multi-camera trend. Consequently, antenna clearance is greatly reduced, and space for layout is increasingly limited.

However, the satellite communication technology has high requirements on radiation characteristics of an antenna. Therefore, how to implement satellite communication in a current architecture is an urgent matter.

### SUMMARY

This application provides an electronic device. The electronic device includes an antenna. A conductive part of a side frame of the electronic device is used as a radiator of the antenna, so that user experience during satellite navigation or communication can be improved.

According to a first aspect, a ground plane; a side frame including a first edge and a second edge that intersect at an angle, where a length of the first edge is greater than a length of the second edge, the second edge includes a first position and a second position, and the side frame is provided with a first slot and a second slot at the first position and the second position respectively; an antenna including: a radiator, where the radiator is a conductive part of the side frame between the first position and the second position; a first feeding circuit and a second feeding circuit, where the radiator includes a feeding point, the first feeding circuit and the second feeding circuit are coupled to the feeding point, the first feeding circuit is configured to transmit an electrical signal in a first frequency band, and the second feeding circuit is configured to transmit an electrical signal in a second frequency band; and a tuning circuit, where the radiator further includes a connection point, and the tuning circuit is coupled between the ground plane and the connection point; and a controller, where the controller is electrically connected to the tuning circuit, and the controller is configured to switch a circuit state of the tuning circuit, so that the antenna operates in the first frequency band or the second frequency band are provided. The first frequency band includes a satellite communication frequency band, and the second frequency band includes at least a part of frequency bands in near field communication or at least a part of frequency bands in a cellular network.

According to this embodiment of this application, the controller may switch the circuit state of the tuning circuit, so that the antenna operates in the first frequency band or the second frequency band, thereby implementing switching between different communication systems, and improving radiation performance of the antenna in the different communication systems.

That the controller is configured to switch the circuit state of the tuning circuit, so that the antenna operates in the first frequency band or the second frequency band may be understood as that an equivalent resistance value, an equivalent capacitance value, or an equivalent inductance value between the connection point and the ground plane is switched, so that the radiator generates a first resonance and a second resonance respectively. A resonance point frequency of the first resonance is different from a resonance point frequency of the second resonance. A resonance frequency band of the first resonance includes the first frequency band, and a resonance frequency band of the second resonance includes the second frequency band, so that the resonance frequency band of the resonance includes the first frequency band or the second frequency band.

In addition, in the structure of the antenna, a wire DM mode of the radiator may be excited. It can be learned from the foregoing embodiments that, when the radiator is disposed on the second edge, radiation efficiency and system efficiency of a resonance generated by the antenna in the wire DM mode are higher. Because a gain of the antenna is related to directionality and efficiency (radiation efficiency and system efficiency) of the antenna, when the efficiency (radiation efficiency and system efficiency) of the antenna is improved, and the directionality remains unchanged, the gain of the antenna can still be improved. Therefore, although a polarization characteristic of radiation generated by the antenna is similar to linear polarization when the electronic device performs communication in the first frequency band (satellite frequency band), and there is a loss of about when the antenna receives a circularly polarized electromagnetic wave. However, the antenna has good efficiency (radiation efficiency and system efficiency).

In addition, when a user performs satellite navigation or communication, a maximum radiation direction of the antenna needs to point to a satellite, to implement satellite alignment (establish a communication connection to the satellite). However, in the technical solution provided in this embodiment of this application, because the radiator is located on the second edge, a maximum radiation direction of a directivity pattern generated by the antenna faces the top (for example, a y direction) of the electronic device. Therefore, when using the electronic device to perform satellite navigation or communication in the first frequency band, the user does not need to change a posture of holding the electronic device, to obtain good user experience.

With reference to the first aspect, in some implementations of the first aspect, the side frame further includes a grounding point, the grounding point is located between the first position and the second position, and the side frame is coupled to the ground plane at the grounding point.

According to this embodiment of this application, the radiator includes the grounding point, and the radiator may generate an additional resonance in a wire CM mode. When the radiator may generate resonances in both the wire CM mode and a wire DM mode, a proportion of the wire DM mode in the first frequency band (a resonance frequency band of the first resonance) may be increased, so that the antenna mainly generates radiation in the wire DM mode in the first frequency band (the resonance frequency band of the first resonance), to improve radiation characteristics (for example, radiation efficiency and system efficiency) of the antenna in the first frequency band.

With reference to the first aspect, in some implementations of the first aspect, the antenna further includes a grounding member, a first end of the grounding member is coupled to the grounding point, a second end of the grounding member is coupled to the ground plane, and the grounding member and the side frame are integrally formed.

According to this embodiment of this application, the grounding member, the side frame, and the middle plate may be milled out by using a same metal part, thereby reducing an error during assembly, and improving a radiation characteristic (for example, bandwidth) of the antenna.

With reference to the first aspect, in some implementations of the first aspect, the feeding point and the connection point are located between the first position and the grounding point.

With reference to the first aspect, in some implementations of the first aspect, the antenna further includes a switch, a common port of the switch is coupled to the feeding point, a first port of the switch is coupled to the first feeding circuit, and a second port of the switch is coupled to the second feeding circuit.

With reference to the first aspect, in some implementations of the first aspect, clearance of the antenna is less than or equal to 1.5 mm.

With reference to the first aspect, in some implementations of the first aspect, clearance of the antenna is greater than or equal to 0.5 mm.

According to this embodiment of this application, the clearance of the antenna may be understood as a minimum distance between the radiator and a metal or electronic element near the radiator. As the clearance of the antenna decreases, radiation performance (for example, bandwidth) of the antenna decreases.

With reference to the first aspect, in some implementations of the first aspect, a size of the radiator in a first direction is less than or equal to 3.5 mm and greater than or equal to 1.5 mm, and the first direction is a thickness direction of the electronic device.

According to this embodiment of this application, when a thickness of the radiator (for example, the size in the first direction) decreases, radiation performance (for example, bandwidth) of the antenna decreases.

With reference to the first aspect, in some implementations of the first aspect, that the controller is configured to switch the antenna to operate in the first frequency band or the second frequency band includes: The controller switches the tuned circuit to be in a first circuit state or a second circuit state based on an operating state of the electronic device. The radiator is configured to generate a first resonance based on the tuned circuit in the first circuit state, where a resonant frequency band of the first resonance includes the first frequency band; and the radiator is configured to generate a second resonance based on the tuned circuit in the second circuit state, where a resonant frequency band of the second resonance includes the second frequency band.

According to this embodiment of this application, the circuit state of the tuning circuit may be understood as an equivalent resistance value, an equivalent capacitance value, or an equivalent inductance value between the connection point and the ground plane. The resonance frequency of the resonance generated by the radiator may be adjusted by using different circuit states.

With reference to the first aspect, in some implementations of the first aspect, that the controller switches the tuned circuit to be in the first circuit state or the second circuit state based on the operating state of the electronic device includes: When a first score is greater than or equal to a second score, the controller switches the tuning circuit to be in the first circuit state, where the first score is a score corresponding to the operating state of the electronic device when the antenna operates in the first frequency band, and the second score is a score corresponding to the operating state of the electronic device when the antenna operates in the second frequency band; and when the first score is less than the second score, the controller switches the tuning circuit to be in the second circuit state.

According to this embodiment of this application, the electronic device may have a plurality of different operating states at the same time, and the first score and the second score may be scores corresponding to different operating states of the controller. Different operating states may correspond to different priorities, and therefore correspond to different scores, so that the electronic device can be limited to an operating state with a high priority.

With reference to the first aspect, in some implementations of the first aspect, the operating state includes at least one of the following: disabled positioning, continuous positioning-outdoor L1 weak signal, continuous positioning-outdoor L1 strong signal, continuous positioning-outdoor L5 weak signal, continuous positioning-outdoor L5 strong signal, continuous positioning-indoor positioning, continuous positioning-indoor and outdoor identification, single-point positioning-foreground, single-point positioning-background, satellite activation, satellite deactivation, satellite preparation, and satellite transceiving.

With reference to the first aspect, in some implementations of the first aspect, the electronic device includes a modem, a first port of the modem is electrically connected to the controller, and a second port of the modem is electrically connected to the tuning circuit.

With reference to the first aspect, in some implementations of the first aspect, that the controller switches the tuned circuit to be in the first circuit state or the second circuit state based on the operating state of the electronic device includes: The controller sends a first signal to the modem, where the first signal indicates the circuit state of the tuned circuit; and the modem switches the circuit state of the tuned circuit based on the first signal.

With reference to the first aspect, in some implementations of the first aspect, currents on the radiator are co-directional at a resonance point of the first resonance.

### BRIEF DESCRIPTION OF DRAWINGS

FIG. 1 is a diagram of an electronic device 10 according to an embodiment of this application;

FIG. 2 is a diagram of a common-mode structure of a wire antenna and corresponding current and electric field distribution according to this application;

FIG. 3 is a diagram of a differential-mode structure of another wire antenna and corresponding current and electric field distribution according to this application;

FIG. 4 is a diagram of another electronic device 10 according to an embodiment of this application;

FIG. 5 shows a simulation result of an S parameter of an antenna 100 in the electronic device 10 shown in FIG. 4;

FIG. 6 shows simulation results of system efficiency and radiation efficiency of an antenna 100 in the electronic device 10 shown in FIG. 4;

FIG. 7 is a diagram of an electronic device 10 according to an embodiment of this application;

FIG. 8 is a diagram of an electronic device 10 according to an embodiment of this application;

FIG. 9 is a diagram of an electronic device 10 according to an embodiment of this application;

FIG. 10 is a diagram of a process in an electronic device 10 according to an embodiment of this application; and

FIG. 11 is a diagram of an antenna switching method 400 according to an embodiment of this application.

### DESCRIPTION OF EMBODIMENTS

The following describes technical solutions of this application with reference to accompanying drawings.

It should be understood that the term “and/or” in this specification describes only a same field for describing associated objects and indicates that three relationships may exist. For example, A and/or B may indicate the following three cases: Only A exists, both A and B exist, and only B exists. In addition, the character “/” in this specification generally indicates an “or” relationship between the associated objects.

In this application, “within a range of . . . ” is used, except when it is separately specified that no end value is included, end values at both ends of the range are included by default. For example, within a range from 1 to 5, two values 1 and 5 are included.

Coupling: The coupling may be understood as direct coupling and/or indirect coupling, and a “coupling connection” may be understood as a direct coupling connection and/or an indirect coupling connection. The direct coupling may also be referred to as an “electrical connection”, which may be understood as physical contact and electrical conduction of components, or may be understood as a form of connection between different components in a line structure through a physical line that can transmit an electrical signal, for example, a printed circuit board (printed circuit board, PCB) copper foil or a conducting wire. The “indirect coupling” may be understood as electrical conduction of two conductors in a spaced/non-contact manner. In some embodiments, the indirect coupling may also be referred to as capacitive coupling. For example, signal transmission is implemented by forming an equivalent capacitor through coupling in a slot between two spaced conductive members.

Element/Component: The element/component includes at least one of a lumped element/component, and a distributed element/component.

Lumped element/component: The lumped element/component is a general name of all elements whose dimensions are far less than a wavelength corresponding to an operating frequency of a circuit. For a signal, a characteristic of the element is constant at any time, regardless of a frequency.

Distributed element/component: A difference between the distributed element and a lumped element lies in that if dimensions of an element are close to or greater than a wavelength corresponding to an operating frequency of a circuit, a characteristic of each point of the element varies with a signal when the signal passes through the element. In this case, the element cannot be considered as a single entity with a constant characteristic, but needs to be referred to as a distributed element.

Capacitor: The capacitor may be understood as a lumped capacitor and/or a distributed capacitor. The lumped capacitor is a capacitive component, for example, a capacitive element. The distributed capacitor (or a distributed type capacitor) is an equivalent capacitor formed by two conductive members that are spaced apart by a predefined slot.

Inductor: The inductor may be understood as a lumped inductor and/or a distributed inductor. The lumped inductor is an inductive component, for example, an inductive element. The distributed inductor (or a distributed type inductor) is an equivalent inductor formed by a conductive member with a predefined length.

Radiator: The radiator is an apparatus configured to receive/send electromagnetic wave radiation in an antenna. In some cases, an “antenna” is understood as a radiator in a narrow sense. The antenna converts guided wave energy from a transmitter into a radio wave, or converts a radio wave into guided wave energy to radiate and receive a radio wave. Modulated high-frequency current energy (or guided wave energy) generated by the transmitter is transmitted to a transmit radiator through a feeder. The radiator converts the energy into predefined polarized electromagnetic wave energy and radiates the energy in a required direction. A receive radiator converts predefined polarized electromagnetic wave energy from a predefined direction of space into modulated high-frequency current energy, and transmits the modulated high-frequency current energy to an input end of a receiver through a feeder.

The radiator may include a conductor with a predefined shape and dimension, for example, a linear radiator or a sheet-shaped radiator. A shape is not limited in this application. In some implementations, the linear radiator may be briefly referred to as a wire antenna. In some implementations, the linear radiator may be implemented by a conductive side frame, and may also be referred to as a side frame antenna. In some implementations, the linear radiator may be implemented by a bracket conductor, and may also be referred to as a bracket antenna. In some implementations, a wire diameter (for example, including a thickness and a width) of the linear radiator or a radiator of the wire antenna is far less than a wavelength (for example, a dielectric wavelength) (for example, is less than 1/16 of the wavelength), and a length may be comparable to the wavelength (for example, the dielectric wavelength) (for example, the length is approximately ⅛ of the wavelength, or ⅛ to ¼ of the wavelength, or ¼ to ½ of the wavelength, or greater). Main forms of the wire antenna include the following: a dipole antenna, a half-wave dipole antenna, a monopole antenna, a loop antenna, and an inverted-F antenna (also referred to as an IFA, Inverted-F Antenna). For example, for the dipole antenna, each dipole antenna usually includes two radiation stubs, and each stub is fed by a feeding portion from a feeding end of the radiation stub. For example, the inverted-F antenna (Inverted-F Antenna, IFA) may be considered as being obtained by adding a grounding path to a monopole antenna. The IFA has a feeding point and a grounding point, and is referred to as the inverted-F antenna because a side view of the IFA is in an inverted-F shape. In some implementations, the sheet-shaped radiator may include a microstrip antenna or a patch (patch) antenna, for example, a planar inverted-F antenna (PIFA). In some implementations, the sheet-shaped radiator may be implemented by a planar conductor (for example, a conductive sheet or a conductive coating). In some implementations, the sheet-shaped radiator may include a conductive sheet, for example, a copper sheet. In some implementations, the sheet-shaped radiator may include a conductive coating, for example, silver paste. A shape of the sheet-shaped radiator includes a circular shape, a rectangular shape, a ring shape, and the like. A shape is not limited in this application. A structure of the microstrip antenna usually includes a dielectric substrate, a radiator, and a ground plane, where the dielectric substrate is disposed between the radiator and the ground plane.

The radiator may also include a slot or a slit formed on a conductor, for example, a closed or semi-closed slot or slit formed on a grounded conductor surface. In some implementations, a radiator with a slot or a slit may be briefly referred to as a slot antenna or a slotted antenna. In some implementations, a radial size (for example, including a width) of the slot or the slit of the slot antenna/slotted antenna is far less than a wavelength (for example, a dielectric wavelength) (for example, less than 1/16 of the wavelength), and a length size may be comparable to the wavelength (for example, the dielectric wavelength) (for example, the length is approximately ⅛ of the wavelength, or ⅛ to ¼ of the wavelength, or ¼ to ½ of the wavelength, or greater). In some implementations, a radiator with a closed slot or slit may be briefly referred to as a closed slot antenna. In some implementations, a radiator with a semi-closed slot or slit (for example, an opening is additionally provided on the closed slot or slit) may be briefly referred to as an open slot antenna. In some embodiments, the slot is long strip-shaped. In some embodiments, a length of the slot is approximately half the wavelength (for example, the dielectric wavelength). In some embodiments, a length of the slot is approximately an integer multiple of the wavelength (for example, one dielectric wavelength). In some embodiments, the slot may be used for feeding through a transmission line bridged on one side or two sides of the slot. In this way, a radio frequency electromagnetic field is excited on the slot, and an electromagnetic wave is radiated to the space. In some implementations, a radiator of the slot antenna or the slotted antenna may be implemented by a conductive side frame that is grounded at two ends, and may also be referred to as a side frame antenna. In this embodiment, it may be considered that the slot antenna or the slotted antenna includes a linear radiator, and the linear radiator is spaced apart from the ground plane and is grounded at two ends of the radiator, to form a closed or semi-closed slot or slit. In some implementations, the radiator of the slot antenna or the slotted antenna may be implemented by a bracket conductor that is grounded at two ends, and may also be referred to as a bracket antenna.

A feeding circuit is a combination of all circuits for receiving and transmitting radio frequency signals. The feeding circuit may include a transceiver (transceiver) and a radio frequency front end (RF front end) circuit. In some cases, in a narrow sense, the “feeding circuit” is a radio frequency chip (RFIC, radio frequency integrated circuit), and the RFIC may be considered to include a radio frequency front end chip and the transceiver. The feeding circuit has a function of converting a radio wave (for example, a radio frequency signal) and an electrical signal (for example, a digital signal). Usually, the feeding circuit is considered as a part of radio frequency.

In some embodiments, an electronic device may further include a test base (which is also referred to as a radio frequency base or a radio frequency test base). A coaxial cable may be inserted into the test base, to test a characteristic of the radio frequency front end circuit or a radiator of an antenna through the cable. The radio frequency front end circuit may be considered as a circuit part coupled between the test base and the transceiver.

In some embodiments, the radio frequency front end circuit may be integrated into the radio frequency front end chip in the electronic device, or the radio frequency front end circuit and the transceiver may be integrated into the radio frequency chip in the electronic device.

It should be understood that any two of a first feeding circuit, a second feeding circuit, . . . , and an N^{th} feeding circuit in this application may share a same transceiver, for example, transmit a signal through a radio frequency channel in the transceiver (for example, a pin (pin) of the radio frequency chip), and may further share a radio frequency front end circuit, for example, process the signal through a switch or an amplifier in a radio frequency front end.

It should be further understood that two of the first feeding circuit, the second feeding circuit, . . . , and the N^{th} feeding circuit in this application usually correspond to two radio frequency test bases in the electronic device.

A matching circuit is a circuit for adjusting a radiation characteristic of the antenna. In some embodiments, the matching circuit is coupled between the feeding circuit and a corresponding radiator. In some embodiments, the matching circuit is coupled between the test base and the radiator. Usually, the matching circuit is a combination of circuits coupled between the radiator and the ground plane. In some embodiments, the matching circuit may include a switch and/or an electronic element, and the switch may be configured to switch between electronic elements connected to the radiator in a coupling manner. The matching circuit has a function of impedance matching and/or frequency tuning. Usually, the matching circuit is considered as a part of the antenna.

Grounding structure/feeding structure: The grounding structure/feeding structure may include a connection member, for example, a metal spring. The radiator is connected to the ground plane in a coupling manner through the grounding structure/connected to the feeding circuit in a coupling manner through the feeding structure. In some embodiments, the feeding structure may include a transmission line/feeder, and the grounding structure may include a grounding line.

End/Point: The end/point in a first end/second end/feeding end/grounding end/feeding point/grounding point/connection point of the antenna radiator cannot be narrowly understood as an endpoint or an end part that is physically disconnected from another radiator, and may further be considered as a point or a segment on a continuous radiator. In some embodiments, the “end/point” may include a connection/coupling area that is on the radiator of the antenna and that is connected to another conductive structure in a coupling manner. For example, the feeding end/feeding point may be a coupling area (for example, an area opposite to a part of the feeding structure) that is on the radiator of the antenna and that is connected to the feeding structure in a coupling manner. For another example, the grounding end/grounding point may be a connection/coupling area that is on the radiator of the antenna and that is connected to the grounding structure in a coupling manner.

Open end and closed end: In some embodiments, the open end and the closed end are, for example, defined based on whether the end is grounded. The closed end is grounded, and the open end is not grounded. In some embodiments, the open end and the closed end are, for example, defined relative to another conductor. The closed end is electrically connected to the another conductor, and the open end is not electrically connected to the another conductor. In some embodiments, the open end may also be referred to as a floating end, a free end, an opening end, or an open-circuit end. In some embodiments, the closed end may also be referred to as a grounding end or a short-circuit end. It should be understood that, in some embodiments, another conductor may be connected in a coupling manner through the open end, to transfer coupling energy (which may be understood as transferring a current).

In some embodiments, the “closed end” may also be understood from a perspective of current distribution. The closed end, the grounding end, or the like may be understood as a current strong point on a radiator, or may be understood as an electric field weak point on a radiator. In some embodiments, the closed end is coupled to an electronic component (for example, a capacitor or an inductor), so that a current distribution characteristic of the current strong point/electric field weak point on the radiator cannot be changed. In some embodiments, a slit (for example, a slot filled with an insulation material) is disposed at or near the closed end, so that the current distribution characteristic of the current strong point/electric field weak point on the radiator cannot be changed.

In some embodiments, the “open end” may also be understood from a perspective of current distribution. The open end, the floating end, or the like may be understood as a current weak point on a radiator, or may be understood as an electric field strong point on a radiator. In some embodiments, the open end is coupled to an electronic component (for example, a capacitor or an inductor), so that a current distribution characteristic of the current weak point/electric field strong point on the radiator cannot be changed.

It should be understood that a radiator end (similar to a radiator at an opening of the open end or the floating end from a perspective of a radiator structure) in a slot is coupled to an electronic component (for example, a capacitor or an inductor), so that the radiator end is a current strong point/electric field weak point. In this case, it should be understood that the radiator end in the slot is actually a closed end, a grounding end, or the like.

A “floating radiator” in embodiments of this application indicates that the radiator is not directly connected to a feeder/feeding stub and/or a grounding line/grounding stub, but is fed and/or grounded in an indirect coupling manner.

It should be understood that “floating” in the “floating end” and the “floating radiator” does not mean that there is no structure around the radiator to support the radiator. In some embodiments, the floating radiator may be, for example, a radiator disposed on an inner surface of an insulation rear cover.

That currents are co-directional/reverse in embodiments of this application should be understood as that directions of main currents on conductors on a same side are co-directional/reverse. For example, when co-directionally distributed currents are excited on a bent conductor or an annular conductor (for example, a current path is also bent or annular), it should be understood that, for example, although directions of main currents excited on conductors on two sides of the annular conductor (for example, on conductors on two sides of a slot in conductors around the slot) are reverse, the main currents still fall within a definition of co-directionally distributed currents in embodiments of this application. In some embodiments, that currents on a conductor are co-directional may mean that the currents on the conductor have no reverse point. In some embodiments, that currents on a conductor are reverse may mean that the currents on the conductor have at least one reverse point. In some embodiments, that currents on two conductors are co-directional may mean that none of the currents on the two conductors has a reverse point and the currents flow in a same direction. In some embodiments, that currents on two conductors are in reverse directions may mean that none of the currents on the two conductors has a reverse point and the currents flow in the reverse directions. It may be correspondingly understood that directions of currents on a plurality of conductors are co-directional/reverse.

That electric fields are co-directional/reverse in embodiments of this application should be understood as that directions of main electric fields (for example, electric fields between conductor and the ground plane) generated by the conductors in the space are co-directional/reverse. For example, when co-directionally distributed electric fields are excited on a bent conductor or an annular conductor (for example, a spacing formed between the ground plane and the conductor is also bent or annular), it should be understood that, for example, directions of electric fields in the spacing are from the ground plane to the conductor or from the conductor to the ground plane, and although main electric fields excited in spacings on two sides of the annular conductor (for example, on conductors around a slot, or in spacings on two sides of a slot) are in reverse directions, the main electric fields still meet a definition of co-directionally distributed electric fields in embodiments of this application. In some embodiments, that electric fields between a conductor and the ground plane are co-directional may mean that the electric fields between the conductor and the ground plane have no reverse point. In some embodiments, that electric fields between a conductor and the ground plane are reverse may mean that the electric fields between the conductor and the ground plane have at least one reverse point. In some embodiments, that electric fields between two conductors and the ground plane are co-directional may mean that none of the electric fields between the two conductors and the ground plane has a reverse point and the electric fields radiate in a same direction (for example, a forward direction of a z-axis). In some embodiments, that electric fields between two conductors and the ground plane are reverse may mean that none of the electric fields between the two conductors and the ground plane has a reverse point and the electric fields flow in reverse directions. That electric fields between a plurality of conductors and the ground plane are co-directional/reverse may be correspondingly understood.

Resonance/resonance frequency: The resonance frequency is also referred to as a resonant frequency. The resonance frequency may have a frequency range, namely, a frequency range in which a resonance occurs. A frequency corresponding to a strongest resonance point is a center frequency point frequency. A return loss of the center frequency may be less than −20 dB. It should be understood that, unless otherwise specified, an antenna/a radiator generates a “first/second . . . resonance” in this application, where the first resonance should be a fundamental mode resonance generated by the antenna/radiator, or a resonance that is generated by the antenna/radiator and that has a lowest frequency. It should be understood that the antenna/radiator may generate one or more antenna modes based on a design, and one fundamental mode resonance may be correspondingly generated in each antenna mode.

Resonance frequency band: A range of a resonance frequency is the resonance frequency band, and a return loss of any frequency on the resonance frequency band may be less than −6 dB or −5 dB.

Communication frequency band/operating frequency band: Regardless of a type of antenna, the antenna constantly operates in a predefined frequency range (a frequency band width). For example, an operating frequency band of an antenna supporting a B40 frequency band includes a frequency in a range of 2300 MHz to 2400 MHz. In other words, the operating frequency band of the antenna includes the B40 frequency band. A frequency range that meets a requirement of an indicator may be considered as an operating frequency band of an antenna.

The resonance frequency band and the operating frequency band may be the same, or may partially overlap. In some embodiments, one or more resonance frequency bands of the antenna may cover one or more operating frequency bands of the antenna.

Electrical length: The electrical length may be a ratio of a physical length (namely, a mechanical length or a geometric length) to a wavelength of a transmitted electromagnetic wave, and the electrical length may satisfy the following formula:

$$\overline{L} = \frac{L}{λ} ,$$

where L is the physical length, and λ is the wavelength of the electromagnetic wave.

Wavelength: The wavelength or an operating wavelength may be a wavelength corresponding to a center frequency of a resonance frequency or a center frequency of an operating frequency band supported by an antenna. For example, it is assumed that a center frequency of a B1 uplink frequency band (with a resonance frequency ranging from 1920 MHz to 1980 MHz) is 1955 MHz. In this case, an operating wavelength may be a wavelength calculated based on the frequency of 1955 MHz. The “operating wavelength” is not limited to the center frequency, and may alternatively be a wavelength corresponding to a non-center frequency of the resonance frequency or the operating frequency band.

It should be understood that a wavelength of a radiation signal in the air may be calculated as follows: (air wavelength or vacuum wavelength)=speed of light/frequency, where the frequency is a frequency (MHz) of the radiation signal, and the speed of light may be 3×10⁸ m/s. The wavelength of the radiation signal in a medium may be calculated as follows: dielectric wavelength=(speed of light/\vec{ξ})/frequency, where E is a relative dielectric constant of the medium. The wavelength in embodiments of this application is usually a dielectric wavelength, and may be a dielectric wavelength corresponding to a center frequency of a resonance frequency, or a dielectric wavelength corresponding to a center frequency of an operating frequency band supported by an antenna. For example, it is assumed that a center frequency of a B1 uplink frequency band (with a resonance frequency ranging from 1920 MHz to 1980 MHz) is 1955 MHz. In this case, a wavelength may be a dielectric wavelength calculated by using the frequency of 1955 MHz. The “dielectric wavelength” is not limited to the center frequency, and may alternatively be a dielectric wavelength corresponding to a non-center frequency of the resonance frequency or the operating frequency band. For ease of understanding, the dielectric wavelength mentioned in embodiments of this application may be simply calculated by using a relative dielectric constant of a medium filled in one or more sides of a radiator.

A person skilled in the art may understand that efficiency is usually indicated by a percentage, and there is a corresponding conversion relationship between the efficiency and dB. Efficiency closer to 0 dB indicates better efficiency of the antenna.

System efficiency (total efficiency) of an antenna: The system efficiency of the antenna is a ratio of input power to output power at an antenna port.

Radiation efficiency of an antenna: The radiation efficiency of the antenna is a ratio of power radiated by the antenna to the space (namely, power that is effectively converted into an electromagnetic wave) to active power input to the antenna. Active power input to the antenna=Input power of the antenna−Loss power. The loss power mainly includes return loss power and metal ohmic loss power and/or dielectric loss power. The radiation efficiency is a value for measuring a radiation capability of an antenna. Both a metal loss and a dielectric loss are factors that affect the radiation efficiency.

A person skilled in the art may understand that efficiency is usually indicated by a percentage, and there is a corresponding conversion relationship between the efficiency and dB. Efficiency closer to 0 dB indicates better efficiency of the antenna.

Antenna return loss: The antenna return loss may be understood as a ratio of power of a signal reflected back to an antenna port through an antenna circuit to transmit power of the antenna port. A smaller reflected signal indicates a larger signal radiated by the antenna to space and higher radiation efficiency of the antenna. A larger reflected signal indicates a smaller signal radiated by the antenna to space and lower radiation efficiency of the antenna.

The antenna return loss may be represented by an S11 parameter, and S11 is one of the S parameters. S11 indicates a reflection coefficient, and the parameter can represent transmit efficiency of the antenna. The S11 parameter is usually a negative number. A smaller S11 parameter indicates a smaller antenna return loss, less energy reflected back by the antenna, namely, more energy that actually enters the antenna, and higher system efficiency of the antenna. A greater S11 parameter indicates a greater antenna return loss and lower system efficiency of the antenna.

It should be noted that, an S11 value of −6 dB is usually used as a standard in engineering. When an S11 value of the antenna is less than −6 dB, it may be considered that the antenna can operate normally, or it may be considered that transmit efficiency of the antenna is high.

Antenna pattern: The antenna pattern is also referred to as a radiation pattern, is a pattern in which relative field strength (a normalized modulus value) of a radiation field of an antenna changes with a direction at a predefined distance from the antenna (a far field), and is usually represented by two plane patterns that are perpendicular to each other in a maximum radiation direction of the antenna.

The antenna pattern usually includes a plurality of radiation beams. A radiation beam with highest radiation strength is referred to as a main lobe, and another radiation beam is referred to as a minor lobe or side lobe. In minor lobes, a minor lobe in an opposite direction of the main lobe is also referred to as a back lobe.

Directivity: the directivity is also referred to as directionality of an antenna. The directivity is a ratio of a maximum power density to an average value in an antenna pattern at a predefined distance from the antenna (a far field), is a dimensionless ratio greater than or equal to 1, and may indicate an energy radiation characteristic of the antenna. Higher directivity indicates a larger proportion of energy radiated by the antenna in a direction, and more concentrated energy radiation.

Antenna gain: The antenna gain represents a degree to which the antenna intensively radiates input power. Usually, a narrower main lobe of the antenna pattern indicates a smaller minor lobe, and a higher antenna gain.

Polarization direction of an antenna: At a given point in space, electric field strength E (vector) is a function of time t. As time goes by, an endpoint of the vector periodically traces a trajectory in space. That the trajectory is a straight line and perpendicular to the ground is referred to as vertical polarization. That the trajectory is horizontal to the ground is referred to as horizontal polarization. That the trajectory is an ellipse or a circle and rotates right-handed or clockwise with the time when viewed in a propagation direction is referred to as right-hand circular polarization (RHCP). That the trajectory is an ellipse or a circle and rotates left-handed or counter-clockwise with the time when viewed in a propagation direction is referred to as left-hand circular polarization (LHCP).

Clearance: The clearance refers to a minimum distance between a radiator of an antenna and a metal or electronic element near the radiator. For example, when a part of a metal side frame of the electronic device is used as the radiator of the antenna, the clearance may refer to a distance between the radiator and a printed circuit board or an electronic element (for example, a camera).

Ground (ground plane, GND): The ground (or ground plane) may generally be at least a part of any grounding layer, grounding plate, grounding metal layer, or the like in an electronic device (for example, a mobile phone), or at least a part of any combination of any grounding layer, grounding plate, grounding component, or the like. The “ground” may be configured to ground a component in the electronic device. In an embodiment, the “ground” may be a grounding layer of a circuit board of the electronic device, or may be a grounding plate formed by a middle frame of the electronic device or a grounding metal layer formed by a metal film below a screen of the electronic device. In an embodiment, the circuit board may be a printed circuit board (PCB), for example, an 8-layer, 10-layer, or 12-layer to 14-layer board with 8, 10, 12, 13, or 14 layers of conductive materials, or an element that is separated and electrically insulated by a dielectric layer or an insulation layer, for example, a glass fiber or a polymer. In an embodiment, the circuit board includes a dielectric substrate, a grounding layer, and a trace layer. The trace layer and the grounding layer are electrically connected through a via. In an embodiment, components such as a display, a touchscreen, an input button, a transmitter, a processor, a memory, a battery, a charging circuit, and a system on chip (SoC) structure may be mounted on or connected to the circuit board, or electrically connected to the trace layer and/or the grounding layer in the circuit board. For example, a radio frequency source is disposed on the trace layer.

Any of the foregoing grounding layer, grounding plate, or grounding metal layer is made of a conductive material. In an embodiment, the conductive material may be any one of the following materials: copper, aluminum, stainless steel, brass and alloys thereof, copper foils on insulation laminates, aluminum foils on insulation laminates, gold foils on insulation laminates, silver-plated copper, silver-plated copper foils on insulation laminates, silver foils on insulation laminates and tin-plated copper, cloth impregnated with graphite powder, graphite-coated laminates, copper-plated laminates, brass-plated laminates, and aluminum-plated laminates. A person skilled in the art may understand that the grounding layer/grounding plate/grounding metal layer may alternatively be made of other conductive materials.

Grounding: The grounding indicates coupling with the ground/ground plane in any manner. In some embodiments, the grounding may be grounding through an entity, for example, grounding through an entity (entity grounding) at a predefined position on a side frame is implemented through some mechanical parts of a middle frame. In some embodiments, the grounding may be grounding through a component, for example, grounding through a component (component grounding) like a capacitor/inductor/resistor connected in series or in parallel.

The following describes technical solutions of embodiments in this application with reference to accompanying drawings.

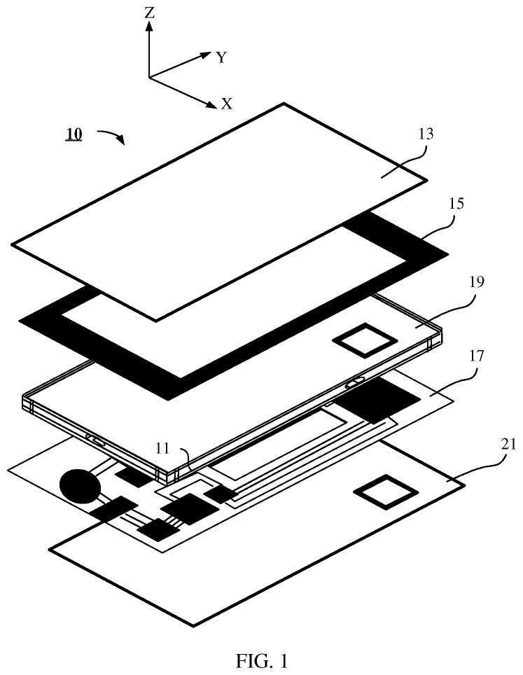

As shown in FIG. 1, an electronic device 10 may include a cover 13, a display/display module 15, a printed circuit board (PCB) 17, a middle frame 19, and a rear cover 21. It should be understood that, in some embodiments, the cover 13 may be cover glass, or may be replaced with a cover made of another material, for example, a cover made of a PET (Polyethylene terephthalate, polyethylene terephthalate) material.

The cover 13 may be tightly attached to the display module 15, and may be mainly configured to protect the display module 15 and prevent the display module 15 from dust.

In some embodiments, the display module 15 may include a liquid crystal display (LCD) panel, a light-emitting diode (LED) display panel, an organic light-emitting semiconductor (OLED) display panel, or the like. This is not limited in embodiments of this application.

The middle frame 19 is mainly used to support the entire electronic device. FIG. 1 shows that the PCB 17 is disposed between the middle frame 19 and the rear cover 21. It should be understood that, in some embodiments, the PCB 17 may alternatively be disposed between the middle frame 19 and the display module 15. This is not limited in embodiments of this application. The printed circuit board PCB 17 may be a flame-resistant material (FR-4) dielectric board, or may be a Rogers dielectric board, or may be a hybrid dielectric board of Rogers and FR-4, or the like. Herein, FR-4 is a grade designation of a flame-retardant material, and the Rogers dielectric board is a high-frequency board. An electronic element, for example, a radio frequency chip, is carried on the PCB 17. In some embodiments, a metal layer may be disposed on the printed circuit board PCB 17. The metal layer may be configured to ground the electronic element carried on the printed circuit board PCB 17, or may be configured to ground another element, for example, a bracketed antenna or a side frame antenna. The metal layer may be referred to as a ground plane, a grounding plate, or a grounding layer. In some embodiments, the metal layer may be formed by etching a metal on a surface of any dielectric board in the PCB 17. In some embodiments, the metal layer configured for grounding may be disposed on a side that is of the printed circuit board PCB 17 and that is close to the middle frame 19. In some embodiments, an edge of the printed circuit board PCB 17 may be considered as an edge of the grounding layer of the printed circuit board PCB 17. In some embodiments, the metal middle frame 19 may also be configured to ground the foregoing element. The electronic device 10 may further have another ground plane/grounding plate/grounding layer. As described above, details are not described herein again.

Due to internal compactness of the electronic device, a ground plane/grounding plate/grounding plane (for example, a printed circuit board, a middle frame, a screen metal layer, and a battery may all be considered as a part of the ground plane) is usually disposed in internal space 0 mm to 2 mm away from an inner surface of the side frame. In some embodiments, a dielectric is filled between the side frame and the ground plane. A length and a width of a rectangle enclosed by an inner surface contour of the filled dielectric may be simply considered as a length and a width of the ground plane. Alternatively, a length and a width of a rectangle enclosed by a contour formed by superposing all conductive parts inside the side frame may be considered as a length and a width of the ground plane.

The electronic device 10 may further include a battery (not shown in the figure). The battery may be disposed between the middle frame 19 and the rear cover 21, or may be disposed between the middle frame 19 and the display module 15. This is not limited in embodiments of this application. In some embodiments, the PCB 17 is divided into a mainboard and a subboard. The battery may be disposed between the mainboard and the subboard. The mainboard may be disposed between the middle frame 19 and an upper edge of the battery, and the subboard may be disposed between the middle frame 19 and a lower edge of the battery.

The electronic device 10 may further include a side frame 11. The side frame 11 may be made of a conductive material like metal. The side frame 11 may be disposed between the display module 15 and the rear cover 21, and circumferentially extends around a periphery of the electronic device 10. The side frame 11 may have four sides surrounding the display module 15, to help fasten the display module 15. In an implementation, the side frame 11 made of the conductive material may be directly used as a conductive side frame of the electronic device 10, for example, form an appearance of the metal side frame. This is applicable to a metal industrial design (ID). In an implementation, an outer surface of the side frame 11 may be made of a conductive material, for example, a metal material, to form an appearance of a metal side frame. In these implementations, a conductive part of the side frame 11 may be used as an antenna radiator of the electronic device 10.

In another implementation, the outer surface of the side frame 11 may alternatively be made of a non-conductive material, for example, plastic, to form an appearance of a non-metal side frame, and this is applicable to a non-metal ID. In an implementation, an inner surface of the side frame 11 may include a conductive material, for example, a metal material. In this implementation, a conductive part of the side frame 11 may be used as a radiator of an antenna of the electronic device 10. It should be understood that the radiator disposed on the inner surface of the side frame 11 (namely, a conductive material on the inner surface) is attached to a non-conductive material of the side frame 11, to facilitate antenna radiation. Both the conductive material and the non-conductive material should be considered as a part of the side frame 11.

The middle frame 19 may include the side frame 11, and the middle frame 19 including the side frame 11 is used as an integrated part, and may support an electronic component in the entire device. The cover 13 and the rear cover 21 are respectively closed along an upper edge and a lower edge of the side frame, to form a casing or a housing of the electronic device. In some implementations, the cover 13, the rear cover 21, the side frame 11, and/or the middle frame 19 may be collectively referred to as a casing or a housing of the electronic device 10. It should be understood that the “casing or housing” may mean a part or all of any one of the cover 13, the rear cover 21, the side frame 11, and the middle frame 19, or mean a part or all of any combination of the cover 13, the rear cover 21, the side frame 11, and the middle frame 19.

At least a part of the side frame 11 may serve as a radiator of an antenna to transmit/receive a radio frequency signal, and there may be a slot between the part of the side frame 11 that serves as the radiator and another part of the middle frame 19, to ensure that the radiator of the antenna has a good radiation environment. In some implementations, the middle frame 19 may be provided with an aperture at the part of the side frame that is used as the radiator, to facilitate radiation of the antenna.

Alternatively, the side frame 11 may not be considered as a part of the middle frame 19. In some implementations, the side frame 11 and the middle frame 19 may be connected and integrally formed. In another embodiment, the side frame 11 may include a protrusion member extending inward, to be connected to the middle frame 19, for example, connected through a spring or a screw, or connected through welding. The protrusion member of the side frame 11 may be further configured to receive a feed signal, so that at least a part of the side frame 11 is used as a radiator of an antenna to receive/transmit a radio frequency signal. A slot may exist between the middle frame 19 and the part of the side frame that serves as the radiator, to ensure that the radiator of the antenna has a good radiation environment, and the antenna has a good signal transmission function.

The rear cover 21 may be a rear cover made of a metal material, or may be a rear cover made of a non-conductive material, for example, may be a non-metal rear cover like a glass rear cover and a plastic rear cover, or may be a rear cover made of both a conductive material and a non-conductive material. In some implementations, the rear cover 21 including the conductive material may replace the middle frame 19, and is used as an integrated part with the side frame 11, to support an electronic component in the entire device.

In some implementations, the middle frame 19 and/or a conductive part of the rear cover 21 may be used as a reference ground of the electronic device 10. The side frame 11, the PCB 17, and the like of the electronic device may be electrically connected to the middle frame for grounding.

The antenna of the electronic device 10 may be further disposed in the side frame 11. When the side frame 11 of the electronic device 10 is made of a non-conductive material, the radiator of the antenna may be located in the electronic device 10 and disposed along the side frame 11. For example, the radiator of the antenna is disposed close to the side frame 11, to minimize a volume occupied by the radiator of the antenna, and is closer to the outside of the electronic device 10, to achieve better signal transmission effect. It should be noted that, that the radiator of the antenna is disposed close to the side frame 11 indicates that the radiator of the antenna may be tightly attached to the side frame 11, or may be disposed close to the side frame 11. For example, there may be a small slot between the radiator of the antenna and the side frame 11.

The antenna of the electronic device 10 may be further disposed in the casing, for example, a bracketed antenna or a millimeter wave antenna (not shown in FIG. 1). Clearance of the antenna disposed in the housing may be obtained through a slit/hole in any one of the middle frame, and/or the side frame, and/or the rear cover, and/or the display, or through a non-conductive slot/aperture formed between any several of the middle frame, and/or the side frame, and/or the rear cover, and/or the display. The clearance of the antenna may be provided, to ensure a radiation characteristic of the antenna. It should be understood that, the clearance of the antenna may be a non-conductive area including any conductive component in the electronic device 10, and the antenna radiates a signal to external space through the non-conductive area. In some implementations, a form of the antenna 40 may be an antenna form based on a flexible mainboard (flexible printed circuit, FPC), an antenna form based on laser-direct-structuring (LDS), or an antenna form like a microstrip disk antenna (MDA). In some implementations, the antenna may alternatively use a transparent structure embedded into a screen of the electronic device 10, so that the antenna is a transparent antenna element embedded into the screen of the electronic device 10.

FIG. 1 shows only an example of some components included in the electronic device 10. Actual shapes, actual sizes, and actual structures of these components are not limited to those in FIG. 1.

It should be understood that, in embodiments of this application, it may be considered that a surface on which the display of the electronic device is located is a front surface, a surface on which the rear cover is located is a rear surface, and a surface on which the side frame is located is a side surface.

It should be understood that, in embodiments of this application, it is considered that when a user holds the electronic device (the user usually holds the electronic device vertically and faces the screen), an orientation in which the electronic device is located has a top part, a bottom part, a left part, and a right part. It should be understood that, in embodiments of this application, it is considered that when a user holds the electronic device (the user usually holds the electronic device vertically and faces the screen), an orientation in which the electronic device is located has a top part, a bottom part, a left part, and a right part.

With continuous evolution of mobile communication technologies, satellite communication technologies gradually become a major feature function of mobile terminal devices. However, an industrial design development trend of an electronic device is a large screen-to-body ratio and a multi-camera. Consequently, antenna clearance is greatly reduced, and space for layout is increasingly limited.

Embodiments of this application provide an electronic device. The electronic device includes an antenna. A conductive part of a side frame of the electronic device is used as a radiator of the antenna, so that user experience during satellite navigation or communication can be improved.

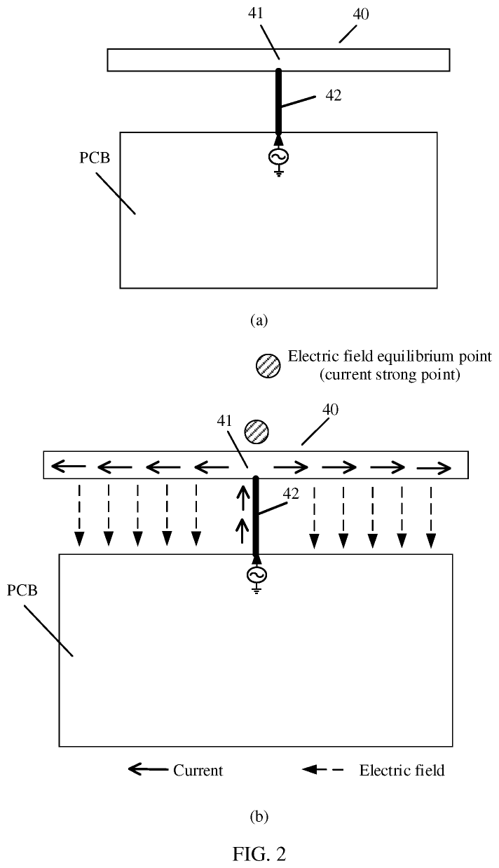

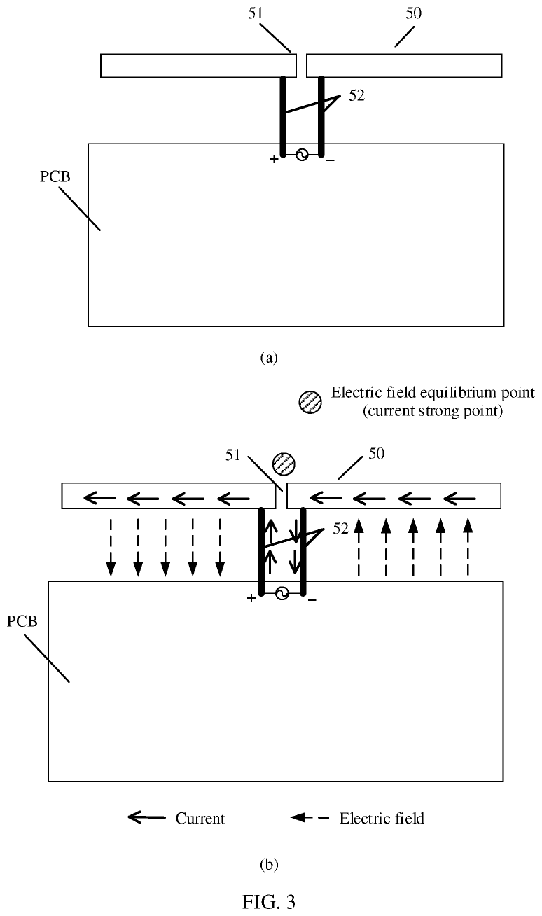

First, two antenna modes in this application are described with reference to FIG. 2 and FIG. 3. FIG. 2 is a diagram of a common-mode structure of an antenna and corresponding current and electric field distribution according to this application. FIG. 3 is a diagram of a differential-mode structure of another antenna and corresponding current and electric field distribution according to this application. Two ends of each of radiators of antennas in FIG. 2 and FIG. 3 are open, and a common mode and a differential mode of the radiators of the antennas may be respectively referred to as a wire common mode and a wire differential mode.

It should be understood that a “common-differential mode” or a “CM-DM mode” in this application is a wire common mode and a wire differential mode that are generated on a same radiator.

### 1. Wire Common Mode (CM)

Herein, (a) in FIG. 2 shows that two ends of a radiator of the antenna 40 are open, and a feeding circuit (not shown in the figure) is connected at a middle position 41. In some implementations, the antenna 40 adopts a symmetrical feed form. The feeding circuit may be connected at the middle position 41 of the antenna 40 through a feeder 42. It should be understood that symmetrical feed may be understood as that one end of the feeding circuit is connected to the radiator and the other end of the feeding circuit is coupled to a ground plane for grounding. A connection point (feeding point) between the feeding circuit and the radiator is located in a center of the radiator. The center of the radiator may be, for example, a midpoint of a geometric structure, or a midpoint of an electrical length (or an area in a predefined range near the midpoint).

The middle position 41 of the antenna 40 may be, for example, a geometric center of the antenna, or the midpoint of the electrical length of the radiator. For example, a joint between the feeder 42 and the antenna 40 covers the middle position 41.

Herein, (b) in FIG. 2 shows the current and electric field distribution of the antenna 40. As shown in (b) in FIG. 2, currents are reversely distributed on two sides of the middle position 41, for example, symmetrically distributed. Electric fields are co-directionally distributed on the two sides of the middle position 41. As shown in (b) in FIG. 2, the currents are co-directionally distributed at the feeder 42. Based on the currents co-directionally distributed at the feeder 42, such feed shown in (a) in FIG. 2 may be referred to as wire CM feed. Based on the currents reversely distributed on two sides of a joint between the radiator and the feeder 42, such an antenna mode shown in (b) in FIG. 2 may be referred to as a wire CM mode (or may also be briefly referred to as a CM mode, where in a wire antenna, the CM mode is the wire CM mode, for example). The current and the electric field shown in (b) in FIG. 2 may be respectively referred to as a current and an electric field in the wire CM mode.

The currents are stronger at the middle position 41 of the antenna 40 (a current strong point is located near the middle position 41 of the antenna 40), and are weaker at two ends of the antenna 40, as shown in (b) in FIG. 2. The electric fields are weaker at the middle position 41 of the antenna 40, and are stronger at the two ends of the antenna 40.

### 2. Wire Differential (DM) Mode

As shown in (a) in FIG. 3, a left end and a right end of each of two radiators of an antenna 50 are open ends, and a feeding circuit is connected at a middle position 51. In some implementations, the antenna 50 adopts an anti-symmetrical feed form. One end of the feeding circuit is connected to one of the radiators through a feeder 52, and the other end of the feeding circuit is connected to the other radiator through the feeder 52. The middle position 51 may be a geometric center of the antenna 50, or a slot formed between the radiators.

It should be understood that, “central anti-symmetrical feed” mentioned in this application may be understood as that a positive electrode and a negative electrode of a feed unit are respectively connected to two connection points near a midpoint of the radiators. In some implementations, signals output from the positive and negative electrodes of the feed unit have a same amplitude but opposite phases. For example, a phase difference is 180°±10°.

Herein, (b) in FIG. 3 shows current and electric field distribution of the antenna 50. As shown in (b) in FIG. 3, currents are co-directionally distributed on two sides of the middle position 51 of the antenna 50, for example, anti-symmetrically distributed. Electric fields are reversely distributed on the two sides of the middle position 51. As shown in (b) in FIG. 3, the currents are reversely distributed at the feeder 52. Based on the currents reversely distributed at the feeder 52, such feed shown in (a) in FIG. 3 may be referred to as wire DM feed. Based on the currents co-directionally distributed on two sides of a joint between the radiator and the feeder 52, such an antenna mode shown in (b) in FIG. 3 may be referred to as a wire DM mode (or may also be briefly referred to as a DM mode, such as for a wire antenna, the DM mode is the wire DM mode, for example). The current and the electric field shown in (b) in FIG. 3 may be respectively referred to as a current and an electric field in the wire DM mode. It should be understood that, based on the currents co-directionally distributed on the two sides of the joints between the radiators and the feeders 52, such an antenna mode shown in (b) in FIG. 3 may also be referred to as a one-half antenna mode or a one-half-wavelength mode, or may be referred to as a one-half mode for short.

In some implementations, in the wire DM mode or the one-half mode, the currents are large at the middle position 51 of the antenna 50 (a current strong point is near the middle position 51 of the antenna 50), and are small at two ends of the antenna 50, as shown in (b) in FIG. 3. The electric fields are weaker at the middle position 51 of the antenna 50, and are stronger at the two ends of the wire antenna 50.

It should be understood that the radiator of the antenna may be understood as a metal mechanical part that generates radiation, there may be one radiator of the antenna, as shown in FIG. 2, or there may be two radiators of the antenna, as shown in FIG. 3, and a quantity of radiators of the antenna may be adjusted based on an actual design or production requirement. For example, for the wire CM mode, the two radiators may alternatively be used, as shown in FIG. 3. Two ends of the two radiators are oppositely disposed and are spaced apart by a slot. A symmetrical feed manner is used at the two ends that are close to each other. For example, a same feed source signal is separately fed into the two ends that are of the two radiators and that are close to each other, so that effect similar to that of the antenna structure shown in FIG. 2 may also be achieved. Correspondingly, for the wire DM mode, one radiator may alternatively be used, as shown in FIG. 2. Two feeding points are disposed at the middle position of the radiator, and an anti-symmetrical feed manner is used. For example, if signals with same amplitudes and opposite phases are respectively fed into the two symmetrical feeding points on the radiator, effect similar to that of the antenna structure shown in FIG. 3 may also be achieved.

3. Wire CM-DM mode

FIG. 2 and FIG. 3 respectively show that, when two ends of a radiator are open, a wire CM mode and a wire DM mode are respectively generated in different feed manners.

When an antenna adopts an asymmetric feed form (including a side feed form and an offset feed form, where a feeding point deviates from a middle position of the radiator), or a grounding point (a position coupled to a ground plane) of the radiator is asymmetric (the grounding point deviates from a middle position of the radiator), the antenna may generate both a first resonance and a second resonance, which respectively correspond to the wire CM mode and the wire DM mode. For example, the first resonance corresponds to the wire CM mode, and current and electric field distribution is shown in (b) in FIG. 2. The second resonance corresponds to the wire DM mode, and current and electric field distribution is shown in (b) in FIG. 3.

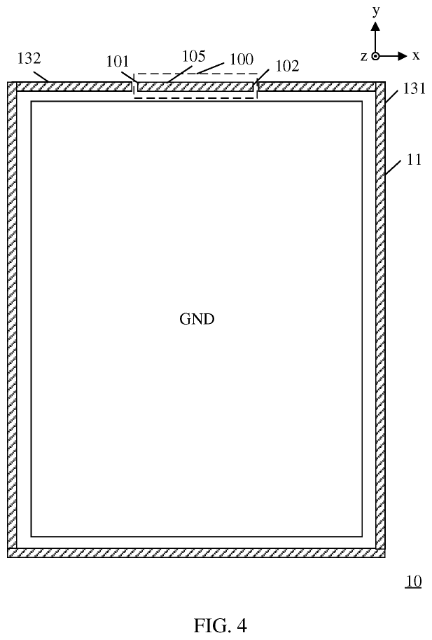

FIG. 4 is a diagram of another electronic device 10 according to an embodiment of this application.

As shown in FIG. 4, a conductive side frame 11 of the electronic device 10 may include a first edge 131 and a second edge 132 that intersect at an angle, and a length of the first edge 131 is greater than a length of the second edge 132.

The second edge 132 may have a first position and a second position, and a first slot 101 and a second slot 102 are provided at the first position and the second position of the side frame 11. A radiator 105 of an antenna 100 may include a conductive part of the side frame between the first position 101 and the second position 102.

In some implementations, the radiator 105 is symmetrical with respect to a virtual axis of the second edge 132, and the second edge 132 has same lengths on two sides of the virtual axis. Due to a specific error during engineering application, when a proportion of a distance between the first position 101 and the virtual axis to a distance between the second position 102 and the virtual axis is greater than or equal to 90% and less than or equal to 110%, it may be considered that the first side frame 105 is symmetrical with respect to the virtual axis of the second edge 132.

It should be understood that, for the antenna, as a structure of the antenna is symmetrical (for example, the radiator 105 is located in a center of the second edge 132), a radiation characteristic (for example, a bandwidth and radiation efficiency) of the antenna is improved.

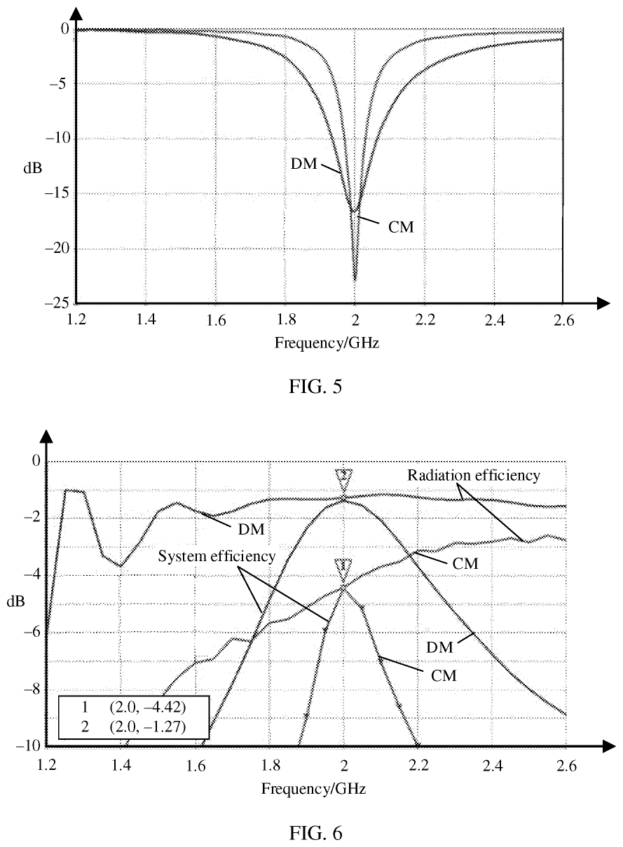

FIG. 5 and FIG. 6 are diagrams of simulation results of the antenna 100 in the electronic device 10 shown in FIG. 4. FIG. 5 shows a simulation result of an S parameter of the antenna 100 in the electronic device 10 shown in FIG. 4. FIG. 6 shows simulation results of system efficiency and radiation efficiency of the antenna 100 in the electronic device 10 shown in FIG. 4.

As shown in FIG. 5, when the antenna shown in FIG. 4 separately uses feed manners shown in FIG. 2 and FIG. 3, a wire CM mode and a wire DM mode may be respectively generated. In both the wire CM mode and the wire DM mode, the antenna may generate resonances near a target frequency band (for example, 2 GHZ).

It should be understood that, for brevity of description, in this embodiment, an example in which the wire CM mode and the wire DM mode are separately excited is merely used for description. With reference to the foregoing embodiment, the wire CM mode and the wire DM mode may alternatively be excited at the same time in a manner of asymmetrical feed (a feeding point deviates from a middle position of the radiator, and side feed or offset feed is included) and/or in a manner in which a grounding point (a position coupled to a ground plane) of the radiator is asymmetrical (the grounding point deviates from the middle position of the radiator).

As shown in FIG. 6, when the first side frame (the radiator) is symmetrical with respect to the virtual axis of the second edge (located in the center of the second edge), at a resonance point (2 GHZ), radiation efficiency is −4.42 dB and system efficiency is −4.47 dB in the CM mode; and radiation efficiency is −1.27 dB and system efficiency is −1.39 dB in the DM mode. It should be understood that, when the first side frame is located in the center of the second edge, a transverse mode may be excited (a proportion of the transverse mode exceeds that of a longitudinal mode), but currents corresponding to the transverse mode cancel each other. As a result, the system efficiency and the radiation efficiency in the CM mode are lower.

For the DM mode, radiation of the antenna is mainly generated by the radiator (the first side frame) in the DM mode, and the system efficiency and the radiation efficiency are better than those in the CM mode when the radiator (the first side frame) is disposed in the center of the second edge.

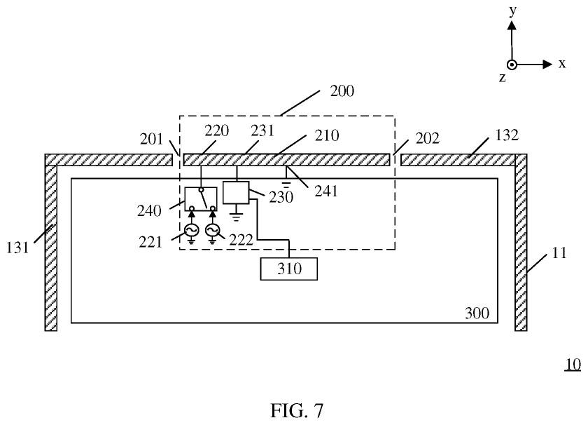

FIG. 7 is a diagram of the electronic device 10 according to an embodiment of this application.

As shown in FIG. 7, the electronic device 10 includes the side frame 11, an antenna 200, a ground plane 300, and a controller 310.

The side frame 11 may include the first edge 131 and the second edge 132 that intersect at an angle, and the length of the first edge 131 is greater than the length of the second edge 132.

It should be understood that the technical solutions provided in embodiments of this application may also be applied to a foldable electronic device. For brevity of description, only an electronic device (non-foldable) including a single display is used as an example for description. In the foldable electronic device, the first edge 131 and the second edge 132 may be understood as a first edge and a second edge corresponding to a case in which the foldable electronic device is in a folded state.

The second edge 132 may have a first position 201 and a second position 202. A first slot and a second slot are respectively provided at the first position 201 and the second position 202 of the side frame 11.

In some implementations, widths of the slots provided at the first position 201 and the second position 202 are greater than or equal to 0.2 mm and less than or equal to 1.5 mm. All slots provided in embodiments of this application may be within the foregoing range. It should be understood that the width of the slot may be understood as a distance between end portions of the side frame on two sides of the slot.

The antenna 200 includes a radiator 210, a first feeding circuit 221, a second feeding circuit 222, and a tuning circuit 230.

The radiator 210 is a conductive part of the side frame 11 at the first position 201 and the second position 202. A first end (an end close to the first position 201) and a second end (an end close to the second position 202) of the radiator 210 are open ends.

The radiator 210 includes a feeding point 220. The first feeding circuit 221 and the second feeding circuit 222 are coupled to the feeding point 220. The first feeding circuit 221 is configured to transmit an electrical signal in a first frequency band. The second feeding circuit 222 is configured to transmit an electrical signal in a second frequency band. The first frequency band and the second frequency band are different.

The first frequency band includes a satellite communication frequency band. In some implementations, the first frequency band may include a transmit frequency band and/or a receive frequency band in satellite communication. For example, in the Tiantong satellite system, the first frequency band may include 1980 MHz to 2010 MHz (a transmit frequency band) and 2170 MHz to 2200 MHz (a receive frequency band). In the BeiDou satellite system, the first frequency band may include 1610 MHz to 1626.5 MHz (a transmit frequency band) and 2483.5 MHz to 2500 MHz (a receive frequency band). Alternatively, the first frequency band and the second frequency band may be applied to another satellite communication system. This is not limited in this embodiment of this application.

In some implementations, the electronic device 10 may perform voice communication through the antenna 200 when the antenna 200 operates in the Tiantong satellite system (the operating frequency band of the antenna 200 includes at least a part of frequency bands in the Tiantong satellite system). In some implementations, the electronic device 10 may send or receive a picture or a short packet through the antenna 200 when the antenna 200 operates in the BeiDou satellite system (the operating frequency band of the antenna 200 includes at least a part of frequency bands in the BeiDou satellite system).

It should be understood that, for brevity of description, that the electronic device 10 performs satellite communication in embodiments of this application may be understood as that the electronic device 10 may send a message or a short packet to a satellite or receive a message or a short packet from a satellite through the antenna 200, or the electronic device 10 may perform voice communication through the antenna 200 via a satellite.

In some implementations, the second frequency band may include at least a part of frequency bands in near field communication (near communication, NC), for example, a Wi-Fi frequency band, a BT frequency band, and a GPS frequency band. Alternatively, the second frequency band may include at least a part of frequency bands in a cellular network, for example, at least a part of frequency bands in a low frequency band (LB) (698 MHz to 960 MHz), at least a part of frequency bands in a medium frequency band (1710 MHz to 2170 MHz), at least a part of frequency bands in a high frequency band (2300 MHz to 2690 MHz), and at least a part of frequency bands in sub 6G. Alternatively, the second frequency band may be at least a part of frequency bands in an ultra wide band (UWB) technology.

For brevity of description, in this embodiment of this application, only an example in which the first frequency band includes a satellite communication frequency band and the second frequency band includes a GPS frequency band is used for description.

The radiator 210 may further include a connection point 231. The tuning circuit 230 is coupled between the ground plane 300 and the connection point 231.

In some implementations, the tuning circuit 230 is a circuit including a switch. The switch may be configured to switch between electronic elements that are coupled to the connection point 231 in different circuit states and that have different resistance values, capacitance values, or inductance values. Alternatively, the switch may be in a turned-off state, so that an electronic element is not connected to the connection point 231 in a coupling manner. Alternatively, the switch may be configured to directly connect the ground plane 300 to the connection point in a coupling manner, and no electronic element is disposed between the ground plane 300 and the connection point.

The controller 310 is electrically connected to the tuning circuit 230. The controller 310 is configured to switch a circuit state of the tuning circuit 230, so that the antenna 200 operates in the first frequency band or the second frequency band.

It should be understood that according to the technical solution provided in this embodiment of this application, the controller 310 may switch a circuit state of the tuning circuit 230, so that the antenna 200 operates in the first frequency band or the second frequency band, thereby implementing switching between different communication systems, and improving radiation performance of the antenna 200 in different communication systems.

That the controller 310 is configured to switch the circuit state of the tuning circuit 230, so that the antenna 200 operates in the first frequency band or the second frequency band may be understood as that an equivalent resistance value, an equivalent capacitance value, or an equivalent inductance value between the connection point 231 and the ground plane 300 is switched, so that the radiator 210 generates a first resonance and a second resonance respectively. A resonance point frequency of the first resonance is different from a resonance point frequency of the second resonance. A resonance frequency band of the first resonance includes the first frequency band, and a resonance frequency band of the second resonance includes the second frequency band, so that the resonance frequency band of the resonance includes the first frequency band or the second frequency band.

In addition, in the structure of the antenna 200, a wire DM mode of the radiator 210 may be excited. It can be learned from the foregoing embodiments that, when the radiator 210 is disposed on the second edge 132, radiation efficiency and system efficiency of a resonance generated by the antenna 200 in the wire DM mode are higher. Because a gain of the antenna is related to directionality and efficiency (radiation efficiency and system efficiency) of the antenna, when the efficiency of the antenna is improved, and the directionality remains unchanged, the gain of the antenna can still be improved. Therefore, although a polarization characteristic of radiation generated by the antenna 200 is similar to linear polarization when the electronic device 10 performs communication in the first frequency band (satellite frequency band), and there is a loss of about 3 dB when the antenna 200 receives a circularly polarized electromagnetic wave. However, the antenna 200 has good efficiency (radiation efficiency and system efficiency).

In addition, when a user performs satellite navigation or communication, a maximum radiation direction of the antenna needs to point to a satellite, to implement satellite alignment (establish a communication connection to the satellite). However, in the technical solution provided in this embodiment of this application, because the radiator 210 is located on the second edge 132, a maximum radiation direction of a directivity pattern generated by the antenna 200 faces the top (for example, a y direction) of the electronic device 10. Therefore, when using the electronic device 10 to perform satellite navigation or communication in the first frequency band, the user does not need to change a posture of holding the electronic device 10, to obtain good user experience.

In some implementations, when the resonance frequency band of the first resonance generated by the radiator 210 and the resonance frequency band of the second resonance generated by the radiator 210 each include the first frequency band and the second frequency band, the resonance point frequency of the first resonance is close to the first frequency band, and the resonance point frequency of the second resonance is close to the second resonance. In this way, the antenna 200 has better radiation characteristics (for example, radiation efficiency) in both the first frequency band and the second frequency band.

In some implementations, the side frame 11 further includes a grounding point 241, and the grounding point 241 is located between the first position 201 and the second position 202. The side frame 11 is coupled to the ground plane 300 at the grounding point 241.

In some implementations, the grounding point 241 may be located in a center area of the radiator 210. The center area includes a center of the radiator 210, and the center of the radiator 210 has two sides of a same length. The central area of the radiator 210 may be understood as an area whose distance from the center of the radiator 210 is within 5 mm.

It should be understood that the radiator 210 includes the grounding point 241, and the radiator 210 may generate an additional resonance in a wire CM mode. When the radiator 210 may generate resonances in both the wire CM mode and a wire DM mode, a proportion of the wire DM mode in the first frequency band (a resonance frequency band of the first resonance) may be increased, so that the antenna 200 mainly generates radiation in the wire DM mode in the first frequency band (the resonance frequency band of the first resonance), to improve radiation characteristics (for example, radiation efficiency and system efficiency) of the antenna 200 in the first frequency band.

In some implementations, the feeding point 220 and the connection point 231 are located between the first position 201 and the grounding point 241.

In some implementations, a length of the radiator 210 between the connection point 231 and the first position 201 is less than or equal to 5 mm.

It should be understood that the radiator 210 has a strong electric field at an open end (a first slot at the first position 201), and the tuning circuit 230 has a better tuning range in an area with a strong electric field.

In some implementations, the antenna 200 further includes a grounding member. A first end of the grounding member is coupled to the grounding point 241, and a second end of the grounding member 240 is coupled to the ground plane 300.

In some implementations, the electronic device 10 includes the middle frame, and the middle frame includes the side frame 11 and a middle plate. In some implementations, the middle plate is electrically connected to the ground plane 300 at a plurality of positions. In some implementations, the middle plate may be considered as a part of the ground plane 300. In some implementations, the side frame 11 is electrically connected to the middle plate via a connection rib structure (for example, the grounding member, which is not shown in the figure). The connection rib structure (for example, the grounding member, which is not shown in the figure) is connected between the side frame and the middle plate, and is integrated with the side frame and the middle plate. For brevity of description, all ground members described in embodiments of this application may be accordingly understood.

It should be understood that the grounding member, the side frame 11, and the middle plate may be milled out by using a same metal part, thereby reducing an error during assembly, and improving a radiation characteristic (for example, bandwidth) of the antenna 200.

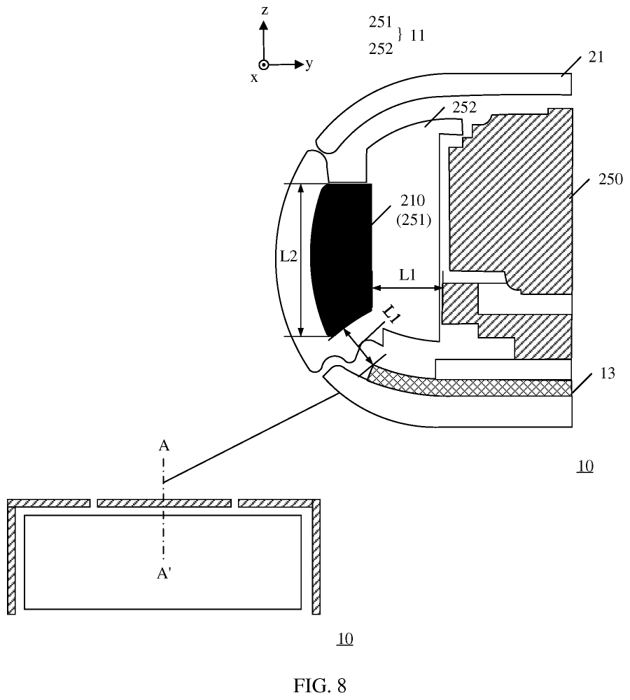

In some implementations, clearance L1 of the antenna 200 may be less than or equal to 1.5 mm, as shown in FIG. 8. In some implementations, the clearance L1 of the antenna 200 may be greater than or equal to 0.5 mm.

It should be understood that the clearance of the antenna 200 may be understood as a minimum distance between the radiator 210 and a metal or electronic element near the radiator 210. As the clearance of the antenna 200 decreases, radiation performance (for example, bandwidth) of the antenna 200 decreases.

In the electronic device 10, the clearance of the antenna 200 may be a distance L1 between the radiator 210 and an electronic element (for example, a camera 250), or may be a distance L1 between the radiator 210 and a metal layer in the display (display module) 15, or may be a distance L1 between the radiator and a metal layer (not shown) in a PCB. The clearance of the antenna 200 may be determined based on an actual layout of the electronic device 10 during production or design.

In some implementations, a size L2 of the radiator 210 in a first direction is less than or equal to 3.5 mm and is greater than or equal to 1.5 mm, as shown in FIG. 8. The first direction is a thickness direction (for example, a z direction) of the electronic device 10.

It should be understood that when a thickness of the radiator 210 (for example, the size L2 in the first direction) decreases, radiation performance (for example, bandwidth) of the antenna 200 decreases.

According to the technical solution provided in this embodiment of this application, when the clearance of the antenna 200 is small and the thickness of the radiator 210 is small, radiation performance of the antenna 200 in different communication systems can be improved by switching between different communication systems.

For brevity of description, in this embodiment of this application, only an example in which the side frame 11 includes a conductor part 251 (for example, aluminum) and an insulation part 252 (for example, plastic) is used for description. During actual production or design, the side frame 11 may alternatively be designed with an all-metal design. This is not limited in this embodiment of this application.

In some implementations, the controller 310 switches, based on an operating state of the electronic device 10, the tuning circuit 230 to be in a first circuit state or a second circuit state, so that the antenna 200 operates in the first frequency band or the second frequency band.

When the tuning circuit 230 is in the first circuit state, the radiator 210 is configured to generate a first resonance, and a resonance frequency band of the first resonance includes the first frequency band. When the tuning circuit 230 is in the second circuit state, the radiator 210 is configured to generate a second resonance, and a resonance frequency band of the second resonance includes the second frequency band.

It should be understood that a circuit state of the tuning circuit 230 may be understood as an equivalent resistance value, an equivalent capacitance value, or an equivalent inductance value between the connection point 231 and the ground plane 300. The resonance frequency of the resonance generated by the radiator 210 may be adjusted by using different circuit states.

In some implementations, the antenna 200 may further include a switch 240. A common port of the switch 240 is coupled to the feeding point 220, a first port of the switch 240 is coupled to the first feeding circuit 221, and a second port of the switch 240 is coupled to the second feeding circuit 222.

It should be understood that the switch 240 may switch an electrical signal fed into the radiator 210. The switch 240 may prevent crosstalk between the feeding circuits (for example, an electrical signal transmitted in the first feeding circuit 221 is fed into the second feeding circuit 222). In some implementations, when the tuning circuit 230 is in the first circuit state, the common port of the switch 240 is electrically connected to the first port, and the first feeding circuit 221 feeds an electrical signal of a first frequency. When the tuning circuit 230 is in the second circuit state, the common port of the switch 240 is electrically connected to the second port, and the second feeding circuit 222 feeds an electrical signal of a second frequency.

In some implementations, for example, the first frequency band includes a satellite communication frequency band, and the second frequency band includes a GPS frequency band. The operating state of the electronic device 10 may include an operating state of a location based service (LBS) and an operating state of satellite communication.

In some implementations, the operating state of the LBS may include at least one of the following: disabled positioning, continuous positioning-outdoor L1 weak signal, continuous positioning-outdoor L1 strong signal, continuous positioning-outdoor L5 weak signal, continuous positioning-outdoor L5 strong signal, continuous positioning-indoor positioning, continuous positioning-indoor and outdoor identification, single-point positioning-foreground, and single-point positioning-background.

In some implementations, the operating state of the satellite communication may include at least one of the following: satellite activation, satellite deactivation, satellite preparation, and satellite transceiving.

In some implementations, the controller 310 may switch the circuit state of the tuning circuit 230 based on a first score and a second score. The first score is a score corresponding to an operating state of the electronic device 10 when the antenna 200 operates in the first frequency band. The second score is a score corresponding to an operating state of the electronic device 10 when the antenna 200 operates in the second frequency band.

In an implementation of this application, the electronic device 10 may have a plurality of different operating states at the same time, and the first score and the second score may be scores corresponding to different operating states of the controller 310. For example, different operating states may correspond to different scores. In some implementations, different scores correspond to different priorities, and a higher score indicates a higher priority.

In some implementations, the electronic device 10 may preferentially be in an operating state with a high priority. For example, when the antenna 200 operates in the second frequency band, and the first score is greater than or equal to the second score, the controller 310 may switch the circuit state of the tuning circuit 230 to the first circuit state, so that the antenna 200 operates in the first frequency band. When the first score is less than the second score, the antenna 200 may keep operating in the second frequency band. When the antenna 200 operates in the first frequency band, the first score is less than the second score, and the controller 310 may switch the circuit state of the tuning circuit 230 to the second circuit state, so that the antenna 200 operates in the second frequency band. When the first score is greater than or equal to the second score, the antenna 200 may keep operating in the first frequency band.

In some implementations, a satellite communication system of the electronic device 10 may be in one or more operating states. The controller 310 may determine the first score based on scores corresponding to the one or more operating states of the satellite communication system. For example, the controller 310 may determine a highest score in the scores corresponding to the one or more operating states as the first score. The LBS system of the electronic device 10 may also be in one or more operating states. The controller 310 may determine the second score based on scores corresponding to the one or more operating states of the LBS system. For example, the controller 310 may determine a highest score in the scores corresponding to the one or more operating states as the second score.

The operating state of the electronic device 10 and the score of the operating state may be preset in the electronic device 10, or may be stored in a server and obtained by the electronic device 10 in real time. This is not limited in this embodiment of this application.

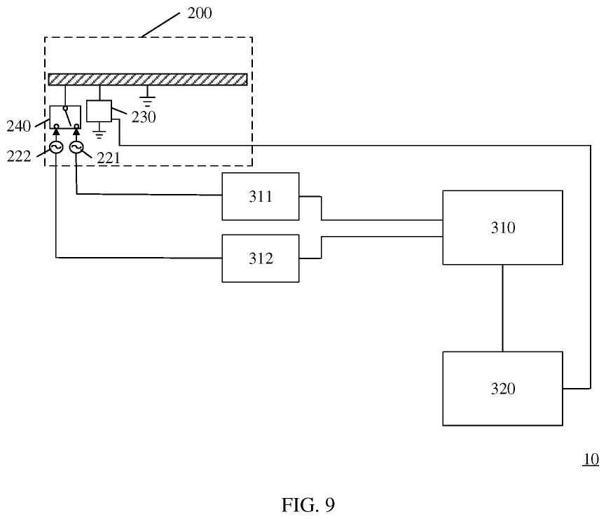

In some implementations, the electronic device 10 further includes a modem 320, as shown in FIG. 9. A first port of the modem 320 is electrically connected to the controller 310, and a second port of the modem 320 is electrically connected to the tuning circuit 230.

It should be understood that, that the modem 320 is configured to process an electrical signal sent or received by the antenna may be understood as modulation, for example, up-conversion, on an electrical signal transmitted by a feeding circuit, or modulation, for example, down-conversion, on an electrical signal received by the antenna.

In some implementations, the controller 310 sends a first signal to the modem 320, where the first signal indicates a circuit state of the tuning circuit 230. The modem 320 switches the circuit state of the tuning circuit 230 based on the first signal.

In some implementations, the electronic device 10 may further include a first chip 311. A first port of the first chip 311 is electrically connected to the controller 310, and a second port of the first chip 311 is electrically connected to the first feeding circuit 221.

It should be understood that the first chip 311 may be a satellite communications-related chip, configured to process a related signal of the first frequency band, and may modulate the signal of the first frequency band. In some implementations, the first chip 311 may also send information related to current satellite communication to the controller 310, for example, satellite activation, satellite deactivation, satellite preparation, satellite transceiving, or a satellite communication frequency band.

In some implementations, the electronic device 10 may further include a second chip 312. A first port of the second chip 312 is electrically connected to the controller 310, and a second port of the second chip 312 is electrically connected to the second feeding circuit 222.

It should be understood that the second chip 312 may be an NC-related chip, configured to process a related signal of the second frequency band, and may modulate the signal of the second frequency band. In some implementations, the second chip 312 may also send information related to the current NC to the controller 310, for example, disabled positioning, continuous positioning-outdoor L1 weak signal, continuous positioning-outdoor L1 strong signal, continuous positioning-outdoor L5 weak signal, continuous positioning-outdoor L5 strong signal, continuous positioning-indoor positioning, continuous positioning-indoor and outdoor identification, single-point positioning-foreground, and single-point positioning-background.

In some implementations, the controller 310 may be an application processor (AP).

It should be understood that all functions implemented by the controller 310 in the foregoing embodiment may be implemented by a module/process in the AP.

In some implementations, the electronic device 10 may further include a system on chip (SoC). The SoC may include the at least two chips described in the foregoing embodiments. For example, the SoC includes the AP and the first chip 311. The AP and the first chip 311 are integrated in a same chip, to reduce space required for layout.

It should be understood that a chip integrated in the SoC is not limited in this embodiment of this application, and may be adjusted based on actual production or design.

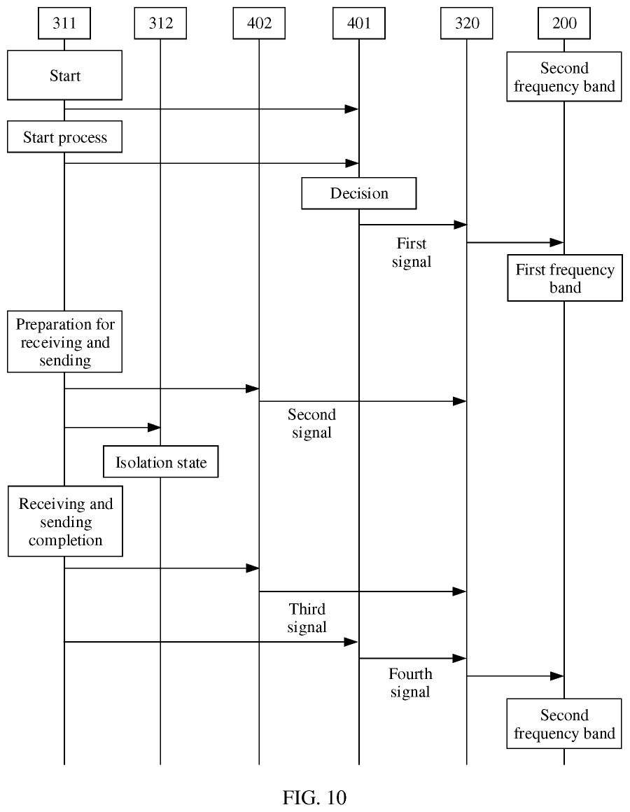

In some implementations, the controller may include a control module 401, as shown in FIG. 10.

It should be understood that the control module 401 may be configured to monitor a communication status between the first chip 311 and the second chip 312.

In some implementations, when the control module 401 monitors that the first chip 311 is started (inserted/reset), the antenna 200 may still operate in the second frequency band, and the electronic device 10 may perform communication in the second frequency band.

In some implementations, when the control module 401 monitors that the first chip 311 is in a start process, the control module 401 makes a decision, and may determine the first score and the second score in the foregoing embodiment. When the first score is greater than the second score, the control module 401 sends a first signal to the modem 320, where the first signal indicates that the tuning circuit is in the first circuit state, and an operating frequency band of the antenna 200 is switched to the first frequency band. The modem 320 controls, based on the first signal, the retuning circuit to be in the first circuit state, and the operating frequency band of the antenna 200 is switched to the first frequency band.

In some implementations, when a call module 402 in the controller detects that the first chip 311 is ready to receive and send a signal, the call module 402 sends a second signal to the modem 320. The second signal indicates to turn off a switch on a cellular-related circuit.

In some implementations, when monitoring that the first chip 311 is ready to receive and send a signal, the second chip 312 controls the second feeding circuit to be in a path isolation state (to prevent crosstalk of a first frequency band signal and damage to an electronic component on the circuit).

In some implementations, when monitoring that the first chip 311 completes receiving and sending a signal, the call module 402 in the controller sends a third signal to the modem 320, where the third signal indicates to turn on a switch on a cellular-related circuit, and the electronic device may perform cellular network communication.

In some implementations, when the control module 401 monitors that the first chip 311 completes receiving and sending a signal, the control module 401 sends a fourth signal to the modem 320, where the fourth signal indicates that the tuning circuit is in the second circuit state, and an operating frequency band of the antenna 200 is switched to the second frequency band. The modem 320 controls, based on the second signal, the tuning circuit to be in the second circuit state, and the operating frequency band of the antenna 200 is switched to the second frequency band.

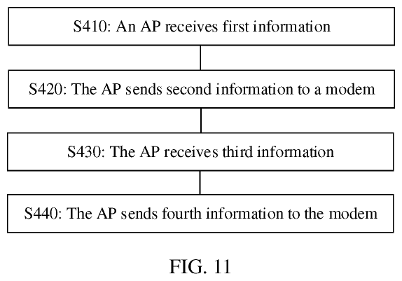

FIG. 11 is a diagram of an antenna switching method 400 according to an embodiment of this application.

As shown in FIG. 11, the switching method 400 includes the following steps.

S410: An AP receives first information, where the first information indicates that a first chip is started (inserted/reset).

In some implementations, a control module in the AP receives the first information sent by the first chip. In some implementations, in this step, an antenna may still operate in a second frequency band, and the electronic device may perform communication in the second frequency band.

In some implementations, before the first chip is started, the antenna may operate in the second frequency band by default, and the electronic device performs communication in the second frequency band.

S420: The AP sends second information to a modem, where the second information indicates the modem to switch a tuning circuit to a first circuit state.

In some implementations, the control module in the AP makes a decision to determine the first score and the second score in the foregoing embodiment. When the first score is greater than the second score, the AP sends the second information to the modem.

In some implementations, the modem controls, based on the second information, the tuning circuit to be in the first circuit state, an operating frequency band of the antenna 200 is switched to a first frequency band, and the electronic device may perform communication in the first frequency band.

S430: The AP receives third information, where the third information indicates that the first chip completes signal receiving and sending.

In some implementations, the control module in the AP receives the third information sent by the first chip.

In some implementations, before the first chip receives and sends a signal, the switching method 400 further includes: The AP (for example, a call module) sends fifth information to the modem, where the fifth signal indicates the modem to disconnect a switch on a cellular-related circuit. The modem disconnects the switch on the cellular-related circuit based on the fifth information.

In some implementations, before the first chip sends and receives a signal, the switching method 400 further includes: A second chip controls a second feeding circuit to be in a path isolation state (to prevent crosstalk of a first frequency band signal and damage to an electronic element on the circuit) (for example, disconnecting an active component in the second feeding circuit).

S440: The AP sends fourth information to the modem, where the fourth information indicates the modem to switch the tuning circuit to be in a second circuit state.

In some implementations, the modem controls, based on the fourth information, the tuning circuit to be in the second circuit state, the operating frequency band of the antenna is switched to the second frequency band, and the electronic device may perform communication in the second frequency band.

In some implementations, after the first chip completes receiving and sending a signal, the switching method 400 further includes: The AP (for example, a call module) sends sixth information to the modem, where the sixth signal indicates the modem to turn on the switch on the cellular-related circuit. The modem turns on the switch on the cellular-related circuit based on the sixth information, and the electronic device may perform communication through a cellular network.

The foregoing descriptions are merely implementations of this application, but are not intended to limit the protection scope of this application. Any variation or replacement readily figured out by a person skilled in the art within the technical scope disclosed in this application shall fall within the protection scope of this application. Therefore, the protection scope of this application shall be subject to the protection scope of the claims.

1. An electronic device, comprising:
a ground plane;
a side frame comprising a first edge and a second edge that intersect at an angle, a length of the first edge being greater than a length of the second edge, the second edge comprises a first position and a second position, and the side frame is provided with a first slot and a second slot at the first position and the second position respectively;
an antenna, comprising:
a radiator, the radiator being a conductive part of the side frame between the first position and the second position;
a first feeding circuit and a second feeding circuit, the radiator comprising a feeding point, the first feeding circuit and the second feeding circuit are coupled to the feeding point, the first feeding circuit is configured to transmit an electrical signal in a first frequency band and the second feeding circuit is configured to transmit an electrical signal in a second frequency band; and
a tuning circuit, the radiator further comprising a connection point and the tuning circuit is coupled between the ground plane and the connection point;
a controller electrically connected to the tuning circuit, the controller is configured to switch a circuit state of the tuning circuit so that the antenna operates in the first frequency band or the second frequency band; and
the first frequency band comprises a satellite communication frequency band and the second frequency band comprises at least a part of near field frequency bands in near field communication or at least a part of cellular frequency bands in a cellular network.

2. The electronic device according to claim 1, wherein the side frame further comprises a grounding point located between the first position and the second position and the side frame is coupled to the ground plane at the grounding point.

3. The electronic device according to claim 2, wherein the antenna further comprises a grounding member, a first end of the grounding member is coupled to the grounding point, a second end of the grounding member is coupled to the ground plane, and the grounding member and the side frame are integrally formed.

4. The electronic device according to claim 2, wherein the feeding point and the connection point are located between the first position and the grounding point.

5. The electronic device according to claim 1, wherein the antenna further comprises a switch and a common port of the switch is coupled to the feeding point, a first port of the switch is coupled to the first feeding circuit, and a second port of the switch is coupled to the second feeding circuit.

6. The electronic device according to claim 1, wherein clearance of the antenna is less than or equal to 1.5 mm.

7. The electronic device according to claim 1, wherein the clearance of the antenna is greater than or equal to 0.5 mm.

8. The electronic device according to claim 1, wherein a size of the radiator in a first direction is less than or equal to 3.5 mm and greater than or equal to 1.5 mm, and the first direction is a thickness direction of the electronic device.

9. The electronic device according to claim 1, wherein the controller being configured to switch the antenna to operate in the first frequency band or the second frequency band comprises:
the controller switches the tuning circuit to be in a first circuit state or a second circuit state based on an operating state of the electronic device;
the radiator is configured to generate a first resonance based on the tuning circuit in the first circuit state, wherein a resonance frequency band of the first resonance comprises the first frequency band; and
the radiator is configured to generate a second resonance based on the tuning circuit in the second circuit state, wherein a resonance frequency band of the second resonance comprises the second frequency band.

10. The electronic device according to claim 9, wherein the controller switching the tuning circuit to be in the first circuit state or the second circuit state based on the operating state of the electronic device comprises:
the controller switching the tuning circuit to be in the first circuit state when a first score is greater than or equal to a second score, wherein the first score corresponds to the operating state of the electronic device when the antenna operates in the first frequency band and the second score corresponds to the operating state of the electronic device when the antenna operates in the second frequency band; and
the controller switching the tuning circuit to be in the second circuit state when the first score is less than the second score.

11. The electronic device according to claim 9, wherein the operating state comprises at least one of:
disabled positioning, continuous positioning-outdoor L1 weak signal, continuous positioning-outdoor L1 strong signal, continuous positioning-outdoor L5 weak signal, continuous positioning-outdoor L5 strong signal, continuous positioning-indoor positioning, continuous positioning-indoor and outdoor identification, single-point positioning-foreground, single-point positioning-background, satellite activation, satellite deactivation, satellite preparation, or satellite transceiving.

12. The electronic device according to claim 9, wherein the electronic device comprises a modem, a first port of the modem is electrically connected to the controller, and a second port of the modem is electrically connected to the tuning circuit.

13. The electronic device according to claim 12, wherein the controller switching the tuning circuit to be in the first circuit state or the second circuit state based on the operating state of the electronic device comprises:
the controller sends a first signal to the modem, wherein the first signal indicates the circuit state of the tuning circuit; and
the modem switches the circuit state of the tuning circuit based on the first signal.

14. The electronic device according to claim 13, wherein currents on the radiator are co-directional at a resonance point of the first resonance.
